(19) United States
(12) Patent Application Publication
(10) Pub. No.: US 2006/0226305 A1
(43) Pub. Date: Oct. 12, 2006

(54) Wristband for keyboard and mouse use

(76) Inventor: Mandana Sheybani, Boca Raton, FL (US)

Correspondence Address: Robert Platt Bell;Registered Patent Attorney, P.O. Box 310, Aurora, NY, 13026, US

(21) Appl. No.: 11/370,790

(22) Filed: Mar. 8, 2006

Related U.S. Application Data
(60) Provisional application No. 60/659,104, filed on Mar. 8, 2005.

(51) Int. Cl. B43L 15/00

(52) U.S. Cl. 248/118.5

(57) ABSTRACT

The present invention provides a wristband for use with a keyboard or mouse (or other applications). The wristband is provided with a padded area formed of foam, beads, or other materials, so as to rest beneath the wrist of the user. A strap is provided to attach the padded portion to the user's wrist such that the padded portion rests beneath the wrist of the user so as to elevate the wrist, reduce strain and the like. Several embodiments were disclosed, including a simple embodiment with an integral VELCRO wristband and simple foam padding. More elaborate versions included a beanbag type pad with a rubber base, and an integral version made from, (for example) fabric coated neoprene rubber (e.g., wetsuit material).

### CROSS-REFERENCE TO RELATED APPLICATIONS

The present application claims priority from Provisional U.S. Patent Application Ser. No. 60/659,104, filed on Mar. 8, 2005, and incorporated herein by reference.

### FIELD OF THE INVENTION

The present invention relates to a wristband for keyboard and mouse use. In particular, the present invention is directed toward a padded wristband with a gripping surface underneath for engaging the surface of a desk or computer table.

### BACKGROUND OF THE INVENTION

A number of existing products are known in the art, which act as wrist rests or wrist pads for use in writing, typing, or for computers (keyboard or mouse use). These devices include keyboard pads that lay in front of the keyboard, mouse Pads that lay in front of the mouse, and carpal tunnel gloves, which have a stiff rod on the bottom of the glove.

Examples of Patents relating to well-known stationary wrist rests and keyboard wrist pads include SHEPPARD, U.S. Pat. No. 6,619,597 (removable pad for a laptop); KENDALL et al., U.S. Pat. No. 6,048,325 (disc-shaped wrist pad); KENDALL et al., U.S. Pat. No. 5,730,711 (disc-shaped wrist pad); and GARCIA et al., U.S. Pat. No. 5,228,655 (wrist pad bar for keyboard).

Such keyboard pads take up space in addition to the keyboard and are only good for the keyboard. Mouse pads with a bump for the wrist take up additional space to the mouse area and are only for the mouse application. Most of the Prior Art pads cannot handle split-keyboards, nor can they handle laptops or keyboards where there is no extra space in front of the keyboard.

Devices attaching to the wrist are also known in the art. Examples of such devices are as follows.

KRUKOVSKY, U.S. Pat. No. 5,472,161 discloses a portable personal wrist support. This device attaches to the wrist and provides support between the wrist and a desk. KRUKOVSKY uses four ball bearings to form a “carriage” so that the wrist support can slide across the desk or other surface.

WIEDENMANN, U.S. Pat. No. 1,510,877 discloses a wrist support that attaches to the wrist. This 1925 reference is not directed towards computers, of course, but rather writing with a pen. Note again the use of ball bearings on the wrist rest to facilitate sliding of the wrist.

BALLOU, U.S. Pat. No. 986,620 discloses another sliding wrist wrest for writing. This wrist rest also attaches to the wrist and is provided with a rotating ball to allow the wrist rest to slide.

GORESLINE, U.S. Pat. No. 89,142, discloses a blotter which attaches to the hand. SETRAKIAN, U.S. Pat. No. 1,522,652 discloses a wrist support for penmen. Note the rotating ball. DICKERSON et al., U.S. Pat. No. Des. 357,010 discloses a rolling wrist rest. LUCERNO et al., U.S. Pat. No. 6,698,687 discloses a wrist support device with rotating balls.

KING, U.S. Pat. No. 5,439,192 discloses a hand word device with a detachable pad. KUHLMAN, U.S. Pat. No. 3,453,751 discloses a writer's aid, which comprises a wrist strap with a cork attached using a cotter pin. GOSHEN et al., U.S. Pat. No. 8,065 discloses a device for penmanship, which appears to attach to the arm and have a solid outer surface.

Other devices are known in the art which disclose devices which may be attached to an arm, or as a glove, or used to support an arm or the like or attach an object to the hand or arm. Examples of such devices are as follows.

TIEDEKEN, U.S. Pat. No. 4,996,977 discloses a tremor control device. This device attaches to the forearm and appears to be designed to limit movement of the arm. THOMSEN, U.S. Pat. No. 5,335,888 discloses a forearm support cradle. This is a padded armrest that attaches to the forearm with two straps. It appears to be rather large and cumbersome.

HASSEL, U.S. Pat. No. 5,193,771 discloses a typist's wrist support. The support includes a wristband, but has attached to it a spoon-shaped device to support the palm of the hand. The underside does not appear to be padded.

O'NEILL, U.S. Pat. No. 6,772,980 discloses an ergonomic apparatus for personal computer use. This rather elaborate apparatus wraps around the neck and attaches to the arms. The drawings are rather crude, but there appears to be a wrist strap in FIG. 4B of O'NEILL. This wrist strap, however, appears to serve the function of attaching a support to the underside of the hand.

PRATT, U.S. Pat. No. 4,809,366 discloses a wristband with an integral back of hand pad. This reference is typical of a number of glove-like devices, which appear to help immobilize a part of the hand or otherwise act as a fingerless glove or the like.

GREENE, U.S. Pat. No. 4,831,997 discloses a wrist strap. This design appears to have a VELCRO™ closure. However, the 90 degree bent design specifically avoids the wrist area, is not padded, and instead appears to be designed to hold a bowstring release mechanism (for archery).

Various wrist rest devices are also known in the art and are described in the following non-Patent literature.

WRIST RESTS: ISSUES AND PRODUCTS, RSI Network, September 1998, discloses several types of wrist rest designs. The wearable forearm supports appears to be fairly large and cumbersome. See www.tifaq.com/articles/wrist_rests&glides-sep98-scott_wright.html

SMART GLOVE and PIL-O-SPLINT, (1999?) appear to disclose glove-like devices known in the art that at least partially immobilize parts of the hand. See http://www.backandbodycenter.com/products-imak.htm

Thus, the idea of a strap-on wrist support is known in the art. However, many of the wrist supports of the Prior Art have ball bearing supports so that they can slide over the desk. Others, such as KUHLMAN, show a fairly sold cork base, which does not appear to provide much in the way of cushioning. The use of ball bearings or other sliding materials may be useful for penmanship applications. However in keyboard or mouse supports, the sliding action may provide less lateral support for the wrist, as the wrist will slide away from the mouse, which is also mounted on a ball. In addition, many of the various designs of the Prior Art do not appear to provide much in the way of padding for comfort and control and thus would present to much pressure to the wrist area and thus would be uncomfortable over time.

### SUMMARY OF THE INVENTION

The present invention provides a wristband for use with a keyboard or mouse (or other applications). The wristband is provided with a padded area formed of foam, beads, or other materials, so as to rest beneath the wrist of the user.

A strap is provided to attach the padded portion to the user's wrist such that the padded portion rests beneath the wrist of the user so as to elevate the wrist, reduce strain and the like.

Several embodiments were disclosed, including a simple embodiment with an integral VELCRO wristband and simple foam padding. More elaborate versions included a beanbag type pad with a rubber base, and an integral version made from, (for example) fabric coated neoprene rubber (e.g., wetsuit material).

The devices may be provided with a base that may be rubberized or otherwise designed to provide GRIP to a working surface, as opposed to the sliding ball bearings of the prior art.

The device is a wrist support for many applications including usage of computer keyboard, computer mouse, or any other keyboard such as cashier machines, split keyboards, laptop keyboard, game stations, or any other work surface that requires the use of the hands such as the sewing board for tailors, and the like.

The device releases tension in either or both wrists independently while typing, using a keyboard, or using a mouse, or simply while having the wrist on any surface, or workstation. The device of the present invention is mobile and portable. The user doesn't have to adjust their hand position to where the keypad is, since this device is strapped around the hand or wrist.

The present invention is space efficient, and can be used with laptops, without having to have a space assigned to the key-pad, or the mouse pad. It can be very useful for small spaces, such as on airplanes and the like, where there is only room for the laptop or the keyboard, but no other space in front of the main application or work-station. The present invention is light and small. The weight and volume of the device makes it very easy to carry around, or travel with.

The present invention provides wrist support to variety of applications, such as usage of keyboard, mouse, or simply having to work with your hand on any surface, where the wrist needs a support. It may also be used for people who already have an injured wrist, and just laying their hand on a couch arm, or a chair that feels uncomfortable, or painful. The present invention may help ease such pain.

The present invention differs from the Prior Art in a number of respects. Unlike conventional keyboard pads, the present invention provides independence of two wrist supports for two hands. The present invention is also space efficient, portable, lightweight, and is many times more comfortable to use. Unlike Prior Art keyboard pads, the present invention provides support to all positions and angles of the hand, at all times, since it straps around the wrist and moves with the hand. Moreover, the present invention may be used for variety of applications at the same time. While a user is wearing the wristband, they may use it for the mouse and for the keyboard at the same time.

### BRIEF DESCRIPTION OF THE DRAWINGS

FIG. 1 is a side view of a first embodiment of the wrist band of the present invention illustrating the device in use for a keyboard.

FIG. 2 is a perspective view of the first embodiment of the present invention.

FIG. 3 is an end view of a variation of the first embodiment of the present invention.

FIG. 4 is a side view of a second embodiment of the wristband of the present invention illustrating the device in use for a keyboard.

FIG. 5 is a perspective view of the second embodiment of the present invention.

FIG. 6 is a side view of the second embodiment of the present invention illustrating the device on a wrist.

FIG. 7 is a side view of a third embodiment of the wristband of the present invention illustrating the device in use for a keyboard.

FIG. 8 is a perspective view of the third embodiment of the present invention.

FIG. 9 is an end of a fourth embodiment of the present invention.

FIG. 10 is a side view of the fourth embodiment of the wristband of the present invention illustrating the device on a wrist.

### DETAILED DESCRIPTION OF THE INVENTION

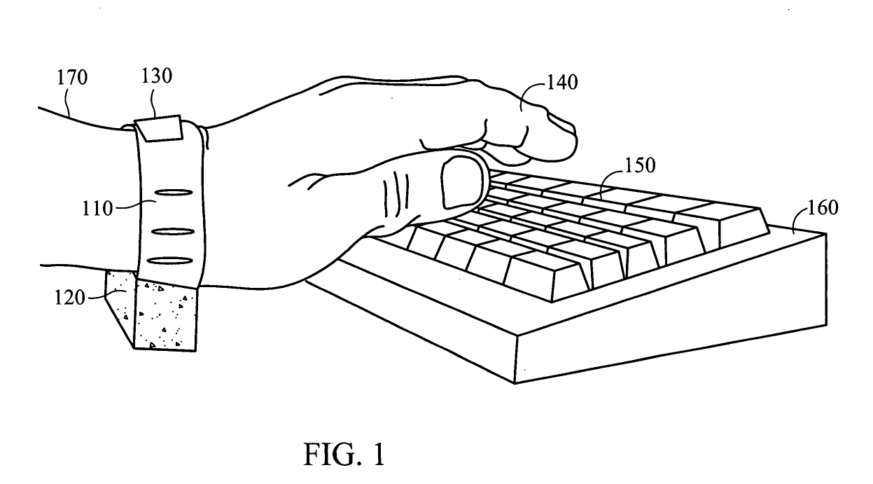

FIG. 1 is a side view of a first embodiment of the wristband of the present invention illustrating the device in use for a keyboard. The first embodiment of the present invention may be strapped to wrist 170 and may comprise a strap 110, a buckle or latching mechanism 130, and support pad 120. As illustrated in FIG. 1, the apparatus elevates the wrist 170 so that fingers 140 are at a comfortable level above keys 150 on keyboard 160. Note that for purposes of illustration, the apparatus is shown being used with a keyboard 160. However, as noted previously, the present invention may also be used for other applications, such as with a mouse or the like.

Support pad 120 may be located below the wrist, and may be made out of any one or more of sponge, foam, dense foam, expanded polyurethane foam, neoprene (wetsuit material) beads, gel, sand balls, plastic beads, or any dense, supportive simultaneously soft material. In one embodiment, support pad 120 may be made integral with strap 110 such that the entire apparatus is substantially one-piece in design. Support pad 120 may comprise a widened portion of strap 110, forming a padded portion. Alternatively, all of strap 110 may be mad thick enough so as to provide the necessary padding for wrist pad 120.

In one embodiment, the entire strap 110 and wrist pad 120 may be made of cloth-coated neoprene (wetsuit material) so as to provide an attractive cloth-covered external appearance. The apparatus may be suitably expanded at wrist pad 120 to provide necessary padding for the wrist. A VELCRO® or other hook-and-loop fastener may be used as fastening means 130 to secure the apparatus to the wrist. In this embodiment, the cost of the device may be kept low so that it may be readily purchased as an impulse purchase, and discarded when worn or dirty.

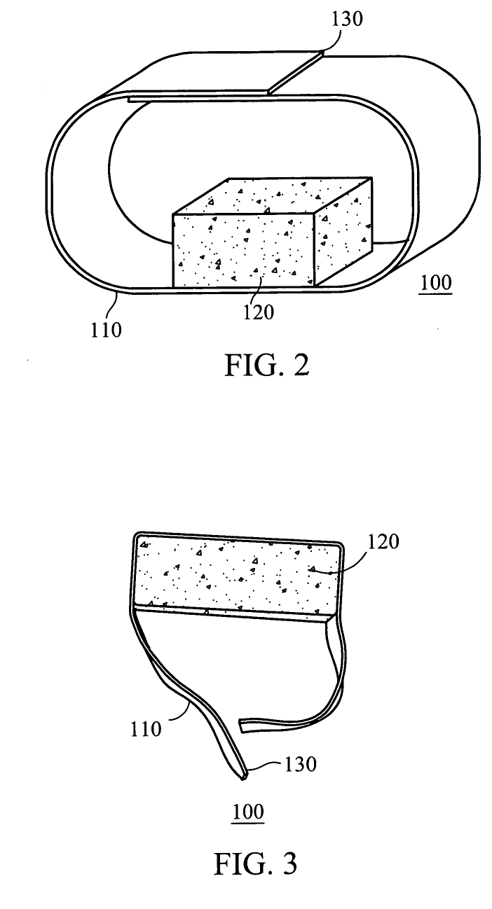

FIG. 2 is a perspective view of the first embodiment of the present invention. Strap portion 110 may be located around the hand or wrist and attached to the center portion using fastening means 130. Strap portion 110 may comprise a VELCRO® or other hook-and-loop fastener strap, thus integrating strap 110 with fastening means 130. Strap 110 may also be made from fabric, sponge, foam, neoprene, or any of the other materials previously mentioned for wrist pad 120 as previously discussed. Strap 110 may also be made from nylon strap material, watchband materials (leather, metal, nylon, cloth, cotton, linen, polyester, or the like) and could even be made as a disposable model using paper, non-woven spun fibers, or other packaging type materials or the like.

If strap 110 is made out of sponge or a dense foam or other padded material, the wristband may be made in one piece as previously discussed where the sponge is cut very thin, for the strap section 110, and is cut very thick under the wrist for the wrist pad 130. If made with the wrist support 130 and strap 110 as separate pieces, the wrist support 130 may be made from a gel, foam, beads, or the like, and may be contained in a fabric and then connected, sewed, glued to the strap, as will be discussed below. The strap 110 may be out of stretch material, fabric, or other kind of strap material and will be strapped easily by VELCRO® or other hook-and-loop fastener, a buckle, or other fastening means 130. If made as a one-piece elastic strap 110, the fastening means 130 may be eliminated, and the device merely stretched over the hand and held in place on the wrist by elastic tension.

FIG. 3 is an end view of a variation of the first embodiment of the present invention. This embodiment illustrates an inexpensive version made using a hook-and-loop fastener strap 110 which incorporates hook-and-loop elements as fastening means 130, thus eliminating the fastening means 130 as a separate component. Padded wrist material 120 may be provided on the inside of the strap 110, secured by adhesive, or on the outside of strap 110. In the preferred version of this embodiment, the padded wrist material 120 is provided as expanded urethane foam provided on the inside of strap 110. This embodiment may be manufactured inexpensively, and thus offered as a free promotional item or as a disposable wrist rest. Note that in the illustration of FIG. 2, two layers of foam 120 are illustrated in this prototype embodiment. Other numbers of layers may be used, including a single layer for manufacturing ease.

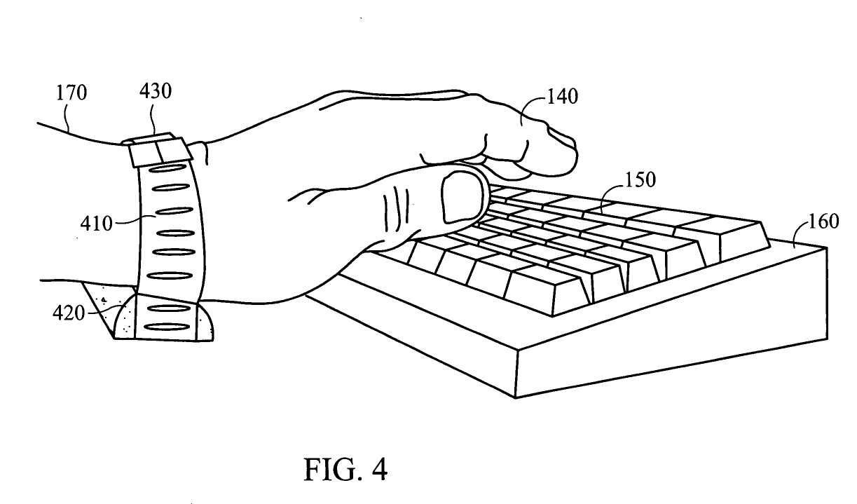

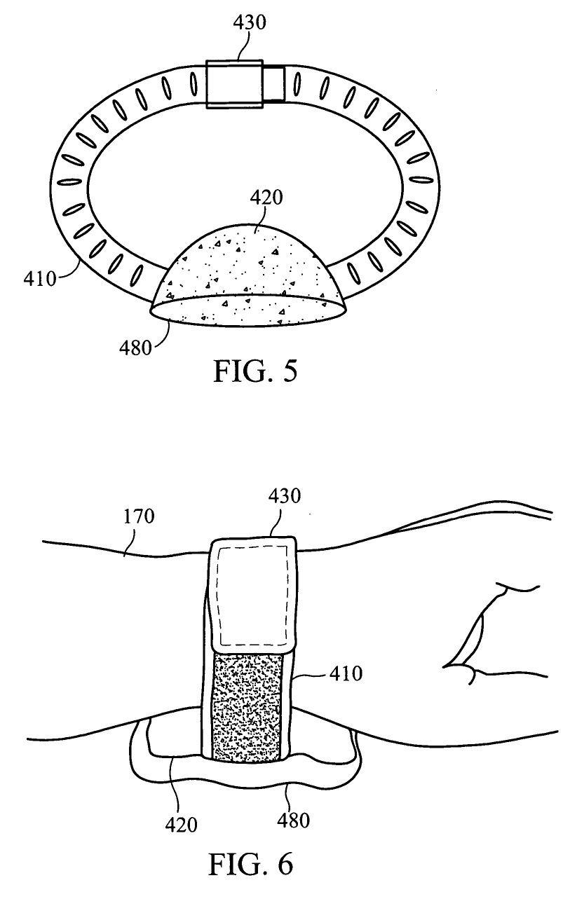

FIG. 4 is a side view of a second embodiment of the wrist band of the present invention illustrating the device in use for a keyboard. FIG. 5 is a perspective view of the second embodiment of the present invention. FIG. 6 is a side view of the second embodiment of the present invention illustrating the device on a wrist. In this embodiment, the apparatus may comprise a strap 410 which may be similar to a nylon watch band or the like, and include a fastening means 430 which may include a hook-and-loop fastener, buckle, or the like. Padded section 420 may comprise a fabric pouch filled with foam padding, or beads (similar to a beanbag) and be formed as a dome shaped pad so as to support the wrist with maximum pressure toward the center of the wrist.

Underneath padded section 420, a rubber (or other) grip surface 480 may be provided to prevent the device from slipping on a desktop or the like. Note that the use of this grip surface represents an additional departure from the Prior Art, in that the device intentionally grips the desktop or other work surface rather then trying to roll on it. The inventor has discovered that greater comfort and ease of use is achieved through a gripping surface than with a low-friction surface such as ball bearings or the like in the Prior Art. Note that grip surface 480 may be made of expanded polyurethane foam, neoprene, or other gripping material, provided with a flat or textured surface.

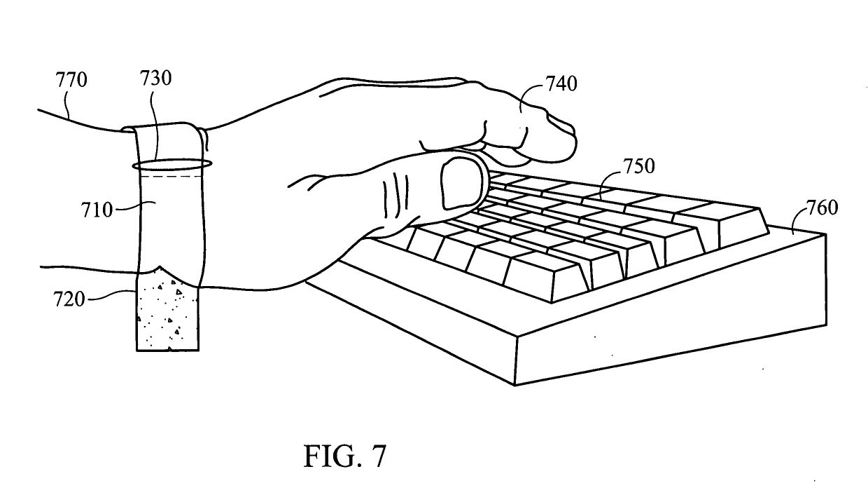

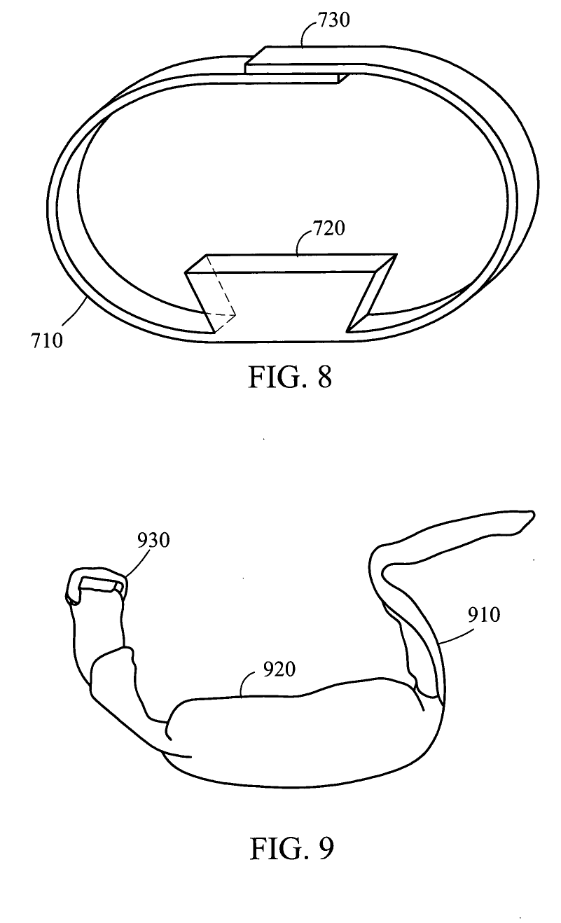

FIG. 7 is a side view of a third embodiment of the wristband of the present invention illustrating the device in use for a keyboard. FIG. 8 is a perspective view of the third embodiment of the present invention. This embodiment illustrates another one-piece embodiment, where padded portion 720 may be formed integrally with strap 710 and may be provided with a hook-and-loop fastener closure means 730.

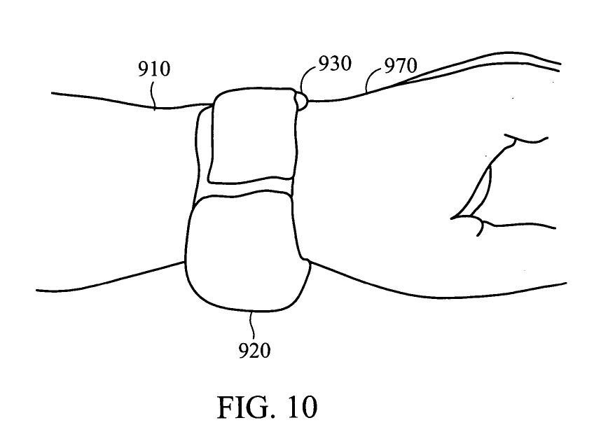

FIG. 9 is an end of a fourth embodiment of the present invention. FIG. 10 is a side view of the fourth embodiment of the wristband of the present invention illustrating the device on a wrist. In this embodiment, a beanbag like wrist support 920 is filled with plastic pellets or other padding material. A watch-like strap 910 is provided with a fastening means 930 including a plastic buckle and a hook-and-loop fastener.

While the preferred embodiment and various alternative embodiments of the invention have been disclosed and described in detail herein, it may be apparent to those skilled in the art that various changes in form and detail may be made therein without departing from the spirit and scope thereof.

I claim:

1. A wristband for reducing wrist strain for a user using a tool comprising at least one of a keyboard, mouse, cashier machines, split keyboards, laptop keyboard, game stations, sewing board for tailors, stylus, pen, and pencil, the wristband comprising:
a band portion for wrapping substantially around the user's wrist;
a padded portion in at least one section of the wristband, so as to rest beneath the wrist of the user.

2. The wristband of claim 1, wherein the padded portion is formed of at least one of foam or beads.

3. The wristband of claim 1, wherein the strap is provided to attach the padded portion to the user's wrist such that the padded portion rests beneath the wrist of the user so as to elevate the wrist from a work surface to reduce strain.

4. The wristband of claim 1, further comprising an attachment means for securing the band portion to the user's wrist.

5. The wristband of claim 4, wherein the band portion and padded portion are integrated into one continuous band covered with a first portion of a hook and loop fastener material, wherein the fastening means comprises a second portion of the hook and loop fastener material provided on one end of the wristband, such that the wristband may be wrapped around the wrist of the user and secured by the second portion of the hook and loop fastener material being secured to any part of the first portion of the hook and loop fastener material.

6. The wristband of claim 1, wherein the padded portion comprises a beanbag pad.

7. The wristband of claim 6, wherein the beanbag includes a rubber base for engaging a work surface to prevent the wristband from slipping on the work surface.

8. The wristband of claim 1, wherein the band portion and the padded portion are made integrally from fabric coated neoprene rubber.

9. The wristband of claim 1, wherein the padded portion is provided with a gripping base surface so as to provide grip to a working surface.

10. The wristband of claim 1, wherein the band portion comprises a continuous portion of hook and loop fastener material, and the padded portion comprises at least one foam portion attached to the hook and loop fastener material, such that the wristband may be wrapped around the wrist of the user and secured by a portion of the hook and loop fastener material being secured to another part of the hook and loop fastener material.

11. A method of reducing wrist strain for a user using a tool comprising at least one of a keyboard, mouse, cashier machines, split keyboards, laptop keyboard, game stations, sewing board for tailors, stylus, pen, and pencil, the method comprising the steps of:
securing to the user's wrist, a wristband having a strap portion wrapping substantially around the user's wrist;
resting the user's wrist onto a work surface over a padded portion provided in at least one section of the wristband, so as to rest beneath the wrist of the user.

12. The method of claim 11, wherein the padded portion is formed of at least one of foam or beads.

13. The method of claim 11, wherein the strap is provided to attach the padded portion to the user's wrist such that the padded portion rests beneath the wrist of the user so as to elevate the wrist from a work surface to reduce strain.

14. The method of claim 11, further comprising the step of securing the band portion to the user's wrist using an attachment mechanism.

15. The method of claim 14, wherein the band portion and padded portion are integrated into one continuous band covered with a first portion of a hook and loop fastener material, wherein the fastening means comprises a second portion of the hook and loop fastener material provided on one end of the wristband, such that the wristband may be wrapped around the wrist of the user and secured by the second portion of the hook and loop fastener material being secured to any part of the first portion of the hook and loop fastener material.

16. The method of claim 11, wherein the padded portion comprises a beanbag pad.

17. The method of claim 16, wherein the beanbag includes a rubber base for engaging a work surface to prevent the wristband from slipping on the work surface.

18. The method of claim 11, wherein the band portion and the padded portion are made integrally from fabric coated neoprene rubber.

19. The method of claim 11, wherein the padded portion is provided with a gripping base surface so as to provide grip to a working surface.

20. The method of claim 11, wherein the band portion comprises a continuous portion of hook and loop fastener material, and the padded portion comprises at least one foam portion attached to the hook and loop fastener material, such that the wristband may be wrapped around the wrist of the user and secured by a portion of the hook and loop fastener material being secured to another part of the hook and loop fastener material.
